(19) United States
(12) Patent Application Publication
(10) Pub. No.: US 2005/0193652 A1
(43) Pub. Date: Sep. 8, 2005

(54) Door jamb assemblies and door assemblies

(75) Inventor: Brent J. Cornell, Green Bay, WI (US)

Correspondence Address: WILHELM LAW SERVICE, S.C., 100 W LAWRENCE ST, THIRD FLOOR, APPLETON, WI, 54911, US

(73) Assignee: Expi-Door Systems Inc., Green Bay, WI (US)

(21) Appl. No.: 10/785,241

(22) Filed: Feb. 24, 2004

(51) Int. Cl. E06B 1/00

(52) U.S. Cl. 52/204.1

(57) ABSTRACT

Door jamb assemblies, and corresponding door assemblies, having elongate inserts received in cavities in corresponding jambs of the door assemblies. Structure and positioning of the insert acts to add stiffness to the jamb assembly. The jamb assembly is readily attached to a framing member of a building such that the jamb assembly moves in unison with movement of the building. Spacing blocks are preferably inserted into the cavity in the jamb, between the jamb face plate and the insert, such that the spacing blocks provide a collective mounting surface which receives the insert. When the door assembly is mounted using fasteners of the invention, further manipulation of the head of the fastener is ineffective to remove the door assembly from the building.

### BACKGROUND

This invention relates to door jambs, jamb elements, jamb assemblies, and door assemblies, typically used as exterior ports of entry into buildings. The invention relates especially to metal door jambs and metal door assemblies. Metal doors and door assemblies are known for use in buildings wherein the building frame is primarily made of metal. Thus, it is known to use a metal door assembly in a building wherein the frame of the building is made primarily of metal.

In buildings wherein the building frame is made primarily of wood, it is known to use wood doors, or metal-clad doors wherein the door slab is either hollow or is filled with wood, or a wood or other fiber composition product. It is also known to use fiberglass doors, foam-filled and polymer skinned doors, and other commercially available door products. For example, in metal pole buildings, especially non-commercial buildings, the building frame is commonly made of wood. The exterior surface of such building comprises a metal skin mounted to the wood frame. Since the exterior of the building is metal, since weather resistance is desirable, the door slab and the jamb assembly preferably have metal exteriors. In such instances, it is conventionally known to use a metal jamb assembly. However, it is difficult to attach known conventional metal jamb assemblies to the building when using conventionally known door-related products and conventional attachment procedures. In addition, the metal jamb assembly is so structured that the metal jamb can be easily contorted, and the metal jamb is susceptible to forced entry, by prying against, and bending, the metal jamb.

FIG. 1 shows a front elevation of a first embodiment of a door assembly 10 as typically shipped from a door supplier to a job site. The door assembly 10 includes a door slab 12 mounted in a door frame 14. The frame 14 includes left 16 and right 18 frame jambs, a frame header jamb 20, and a threshold 22. In FIG. 1, the left frame jamb 16 functions as the strike jamb; and the right frame jamb 18 functions as the hinge jamb. The slab 12 is mounted to the frame 14 by a plurality of hinges 24, at the hinge jamb. The slab connects to the strike jamb by a latch assembly, represented in FIG. 1 by a door knob 26.

FIG. 2 shows a cross-section of the left frame jamb 16, taken at 2-2 of FIG. 1. Other than adaptation for hinges rather than for the strike, the hinge jamb, in the embodiments discussed herein, typically can be structurally the same as the strike jamb.

As illustrated in FIG. 2, jamb 16 includes an inner flange 28 which is disposed inwardly in the building when the door assembly is installed in a building. Jamb 16 further includes an outer flange 30 which is disposed outwardly of the building when the door assembly is installed in the building. Inner and outer flanges 28, 30 are connected to each other by a jamb face plate 32 which runs generally perpendicular to flanges 28, 30. Jamb face plate 32 has an exterior rabbet section 34, an interior rabbet section 36, and a door stop 38 between the inside and outside rabbet sections. Rabbet sections 34, 36, and door stop 38 run generally perpendicular to flanges 28, 30. Flanges 28, 30 each include an in-turned flange end 40 which defines an empty space 42 between the distal end 43 of the respective in-turned flange end, and the main body of the respective flange 28 or 30. In some embodiments of jamb 16, 18, distal ends 43 of flanges 28, 30 are omitted.

A first conventional (not the invention) out-swing door frame assembly, ready to be installed in a metal frame building, is illustrated in cross-section in FIG. 3. As seen in FIG. 3, an open-sided C-channel 44 is mounted to e.g. a jamb 16, e.g. to the jamb illustrated in FIGS. 1 and 2, at in-turned flange ends 40, using screws 46. Typically, the C-channel and jamb are shipped separately to the construction site, and are assembled to each other at the construction site to form the jamb assembly shown. After the jamb and C-channel are so assembled at the construction site, the open side of the C-channel receives a bottom anchor which secures the C-channel into the e.g. concrete floor (not shown) and a top anchor which receives the C-channel into a top girt through apertures 50. Flange 48 of the C-channel is then used for attaching the exterior metal panel 51 to the building using fasteners 52.

A second conventional door frame assembly, used for mounting an in-swing steel door frame into an opening in a wood frame building, is shown in cross-section in FIG. 4. As shown in FIG. 4, typically in a wood frame building construction, the door rough opening, into which the door frame assembly is to be placed, is framed with a double stud structure employing first 54 and second 56 studs.

In the FIG. 4 structure, a sheet metal connecting bracket 58, known in the art as a “universal stud anchor”, includes a mounting plate 60, bracket retainers 61, and legs 62. Mounting plate 60 is received inside the inner space 59 which is defined inside the jamb 16, 18, e.g. between inner and outer flanges 28, 30, thus to define the jamb assembly. As used herein, inner space 59 includes the earlier-mentioned empty space 42 which is located between the distal end 43 of the in-turned flange end and the main body of the respective flange 28 or 30.

A major face of a typical such universal stud anchor bracket 58 is shown, at mounting plate 60, as generally spanning the primary cross-section of inner space 59 in FIG. 4, transverse to, and generally perpendicular to, the length of the respective jamb. First and second bracket retainers 61 extend from mounting plate 60 into empty spaces 42 to assist in holding bracket 58 in place relative to the jamb, e.g. jamb 16 or jamb 18. First and second legs 62 of bracket 58 extend from mounting plate 60 and are twisted and bent, typically at the job site, to fit the contours of stud 54, thereby to lie parallel to the surfaces of the stud, for securement to stud 54. Legs 62 are typically twisted 90 degrees from the plane of mounting plate 60, and are bent to follow the surfaces of building stud 54. Screws 64 are installed through legs 62 and into stud 54, thereby to secure legs 62 to stud 54, and correspondingly to secure bracket 58, and thus the jamb assembly, to stud 54, namely to the building.

A plurality of such brackets 58 are mounted in each of the left and right jambs, and optionally the header jamb, sufficient in number to anchor the door frame assembly in the rough opening. Typically, between four and six such brackets are used at each of jamb 16 and jamb 18 for a nominally 80 inch high door rough opening. Contrary to the prior art embodiment of FIG. 3, this prior art embodiment can be assembled as a door assembly prior to being mounted in the doorway rough opening.

Such door assembly is mounted in a building rough opening by first inserting the brackets 58 in the open sides of the jambs at spaced locations along the lengths of the respective jambs. Brackets 58 are used in both left and right jambs 16, 18, and are optional in header jamb 20. Prior to inserting the door assembly into the rough opening, legs 62 are twisted about 90 degrees and, on e.g. the inner side of the door assembly, are bent so as to clear the rough opening. As used here, inner means relative to the interior of the building. Then, the door assembly is inserted/tipped into the rough opening, and legs 62 are bent to conform to the surfaces of the corresponding frame members, such as studs 54.

Shims are inserted between the door jamb assembly and the building members, to properly align and square the door relative to the building frame. But the shims can only be inserted in proximity to the respective brackets 58. Shims can be used only at these locations because there is nothing inside the throat of the jamb against which to wedge the ships to effectively hold the frame in place. Legs 62 are then secured to the studs, thus securing the door assembly to the building framing members as shimmed, at the rough opening. Of course, once the frame is in place in the rough opening, any of the legs can be attached to e.g. stud 54 before any other, or all, of the legs are bent to conform to the surfaces of the respective building framing members.

While brackets 58 successfully mount the door assembly to the building, the design of brackets 58 leaves an undesirable level of potential movement of the door frame relative to the building, after attachment of the door assembly to the building. For example, legs 62 must be fabricated from metal sufficiently soft as to be twisted about 90 degrees, and to be bent to fit against stud 54 or other building framing members, at the construction site. Plate 60, which is friction fit into the inner space 59 inside the flange, is typically made of the same relatively softer metal as legs 62, thereby to accommodate the bending of the legs. Indeed, bracket 58 is known as a unitary piece of sheet metal product. Such requirement for bending thus operates as a limiting factor to limit the degree of rigidity of flange 58, thereby limiting the rigidity which can be achieved with mounting plate 60. Thus, however carefully the workers fit and install the door assembly, brackets 58 inherently exhibit an undesirable degree of flex capacity between plates 58 and the points where screws 64 attach the legs to the building at studs 54. It is that flex capacity which defines the inherent capability of the door assembly to move relative to the building after the door assembly is mounted in the building.

Brackets 58 are placed at spaced locations in the left and right jambs 16, 18. For example, typically 3 to 4 brackets are used in each of the left and right jambs. Brackets 58 are made of thin sheet metal, such as 20 gauge sheet metal, about 0.038 inch thick, and the material must be so selected in order that the bracket legs be sufficiently bendable to accommodate twisting and bending, which enables placement of legs 62 in surface-to-surface relationship with studs 54, thereby facilitating attachment of the legs to the studs, as well as providing for an aesthetically pleasing appearance and thin cross-section of the legs; which facilitates covering fasteners 64 with trim or other finish material.

In light of the above, the vast majority of the length of the inner space 59 defined on the interior of the jamb is empty, and thus is not occupied by a bracket 58, not occupied by any other structure which prevents or limits flexing of the jamb or movement of the jamb relative to the building. Namely, the interior cavity of the jamb, which is located between the inner surfaces of rabbets 34, 36 and stud 54 is largely empty, whereby the jamb has substantial capacity to flex as the door is opened and closed, and as other typically-imposed forces are expressed on the door frame. Such flexing is, of course, also undesirable for purposes of deterring unauthorized entry through the doorway.

In addition, because of the flexing capability of legs 62, such typical forces cause the door frame/jamb assembly, after installation in the building has been completed, to move relative to the building frame. Namely, even though legs 62 are properly anchored to stud 54 by screws 64, even though legs 62 are properly configured relative to stud 54 and flange ends 40, according to normal skills in the building trades, the door frame/jamb assembly can move relative to the building. Such movement is, of course, undesirable in that the overall concept of the building structure is that the respective structural elements of the building, including the door jamb assemblies, reinforce each other, and move together, thereby to fulfill and preserve the structural integrity of the building.

FIG. 5 shows still another prior art structure by which an in-swing metal door assembly is conventionally mounted to a wood frame building at the rough opening. As suggested in FIG. 5, the jamb assembly comprises conventional left and right jambs, which are anchored to the building framing members using about 10 to 20 standard screws through holes in rabbets 34, 36. Longer e.g. mounting screws 66 are driven through holes in door stop 38, across inner space 59, and into stud 54. Such mounting includes using mounting screws spaced along the length of the jamb, and behind door slab 12, e.g. in interior rabbet section 36.

The embodiment of FIG. 5, like that of FIG. 4, is subject to flexing, dimpling, and/or other distortion of the jamb at rabbets 34, 36, and door stop 38 because of the expanse of the inner space 59 between the contact points of the fasteners at locations 34, 36, and 38, and at stud 54. Relatively smaller and thinner common mounting screws are used due to the relatively larger quantity of screws needed to anchor the jamb 16, 18 which again makes shimming of the jamb assembly difficult because of the lack of structure in inner space 59. The use of the smaller and thinner common mounting screws in the prior art commonly results in bending or breaking of such screws. Jamb 16 can, of course, be made of thicker metal, to attenuate such flexing, dimpling, or other distortion, but at undesirable, unacceptable, incremental cost, whereby such solution is not acceptable.

Thus, it would be desirable to provide jamb assemblies and door assemblies which are easily installed/mounted in buildings, typically preferably as pre-assembled door assemblies, and which are so rigidly mounted in the buildings as to not generally move relative to the buildings to which they are mounted/installed.

### SUMMARY

The invention provides door jamb assemblies, and corresponding door assemblies. Such door assembly includes e.g. a left jamb assembly, a right jamb assembly, a header jamb, and a door slab. The left and right jamb assemblies have elongate inserts received in cavities in the corresponding jambs. The structure and positioning of the respective insert in such jamb acts to add stiffness to the jamb assembly. The jamb assembly, as part of a door assembly, is readily attached to e.g. a wood framing member of a building such that the jamb assembly moves in unison with movement of the building framing member. Preferably, both the hinge jamb assembly and the strike jamb assembly are so structured that the door assembly, as a unit, moves in unison with the building members to which they are mounted. The jamb assemblies of the invention provide an efficient interface which readily anchors a metal frame to wood framing members of a building. Jamb assemblies of the invention provide for quick installation, while the inserts provide a flat surface as basis for efficient adjustment of the door in a plumb, level orientation, and efficient shimming of the door assembly into a wood structure, wood frame.

Spacing blocks are preferably inserted into the cavity in the jamb, in specific locations which clear strike reinforcements, strike dust covers, hinge reinforcements, hinge dust covers, and like structure inside the elongate cavity in the jamb. Such spacing blocks provide a collective mounting surface which receives the insert. The insert generally extends along a substantial portion of the length of the jamb, from the spacing blocks or other structure which interfaces with the jamb face plate, to the opening which defines the exit path from the elongate cavity. The insert is attached to spacing blocks which extend between the interior and exterior flanges, and which extend to rabbets 34, 36. The insert is desirably notched at the strike location to provide for a level mounting surface so as to provide a level surface of the insert at elongate exit opening of the elongate cavity of inner space 59.

Special two-part fasteners are used to mount the jamb assemblies, namely door assemblies made with such jamb assemblies, to framing members of the building which define the rough opening in which such door assembly is mounted. When the door assembly is mounted using such fasteners, and the body of the fastener is embedded in the insert in the jamb assembly and in the respective building frame member, further manipulation of the head of the fastener is ineffective to remove the body of the fastener from the building frame member or the jamb assembly. Accordingly, manipulation of the fastener head is ineffective to remove the door assembly from the building.

In a first family of embodiments, the invention comprehends a jamb assembly, adapted for use in a door frame. The jamb assembly comprises an elongate jamb having a length, and comprising an inner flange having a first proximal edge and a first distal edge, an outer flange having a second proximal edge and a second distal edge, and a jamb face plate extending between the inner flange at the first proximal edge and the outer flange at the second proximal edge, the elongate jamb defining an elongate cavity therein extending along the length of the elongate jamb, and extending from at or adjacent an inner surface of the jamb face plate to an elongate opening proximate the first and second distal edges of the inner and outer flanges, the elongate opening being defined along the length of the elongate jamb between the inner and outer flanges; and as a separate and distinct element, at least one elongate reinforcing insert, having a length, received in the elongate cavity and extending at least to the elongate opening, the reinforcing insert operating to increase stiffness of the jamb assembly.

In some embodiments, the elongate reinforcing insert interfaces either directly or indirectly with the elongate jamb at at least three spatially-displaced points at a given locus along the length of the elongate jamb, optionally along substantially all of the common lengths of the insert and the jamb.

In some embodiments, a width of the elongate reinforcing insert between a first element of the inner flange and a first element of the outer flange extends a distance generally aligned with the inner and outer flanges, thereby filling a substantial portion of the elongate cavity between the jamb face plate and the elongate opening.

In some embodiments the elongate insert fills substantially all space in the cavity between an element of the inner flange and an element of the outer flange, and fills a substantial portion of all space between the elongate opening and the jamb face plate.

Some embodiments include a void space in the cavity between the insert and a second element of at least one of the inner flange and the outer flange.

Some embodiments further comprise at least first and second spacing blocks disposed between the insert and the jamb face plate, and optionally the spacing blocks collectively provide a mounting surface which receives a corresponding surface of the insert.

In some embodiments, the spacing blocks are spaced from each other along the length of the jamb.

In some embodiments, the spacing blocks collectively provide a mounting surface, optionally a planar mounting surface, which receives a corresponding surface of the insert, whereby the spacing blocks serve as indirect interfaces between the insert and the jamb face plate.

In some embodiments the jamb assembly further comprises a draw fastener which draws the insert toward the jamb face plate.

In some embodiments, the jamb assembly comprises, in the elongate cavity, one or more elements of door interface hardware permanently mounted to the jamb, the door interface hardware having first thicknesses thereof extending away from the jamb face plate and toward the elongate opening, and the spacing blocks collectively provide a mounting surface disposed generally between the elongate opening and the door interface hardware.

In some embodiments, the door interface hardware interrupts a de minimis portion of, and thereby extends through a de minimis area of, an imaginary plane which defines the mounting surface.

In some embodiments, a projected area of the jamb can be defined from the direction of the elongate opening, the jamb assembly further comprising, in the elongate cavity, one or more elements of door interface hardware permanently mounted to the jamb, the spacing blocks and the door interface hardware occupying different portions of the projected area of the jamb.

In some embodiments, the spacing blocks extend from the inner flange to the outer flange.

In some embodiments, the spacing blocks, and optionally the insert, are friction fitted between respective portions of the inner and outer flanges.

The invention further comprehends door assemblies which comprise the hinge jamb assemblies of the invention.

Yet further, the invention comprehends a building comprising a doorway, and a door assembly of the invention in the doorway.

In some embodiments, the door assembly is mounted in the doorway using a fastener having a detachable head, whereby manipulation of the head is ineffective to remove the fastener from the door assembly.

In a further family of embodiments, the invention comprehends a doorway, and a door assembly mounted in the doorway, optionally mounted in a building. The doorway is defined by a rough opening, and building framing members defining the rough opening. The door assembly comprises a plurality of elongate jambs, each having a length, and comprising an inner flange, an outer flange, and a jamb face plate, and an elongate cavity therein extending along the length of the elongate jamb, and defined between the inner and outer flanges and outwardly of the jamb face plate to an elongate opening into the elongate cavity, At least one of the elongate jambs further comprises, as a separate and distinct element, at least one elongate reinforcing insert received in the elongate cavity and extending at least to the elongate opening. The rough opening is defined by a single thickness of structural member used to define a frame of the building in facing relationship with the at least one elongate jamb which comprises the reinforcing insert, and wherein a double thickness of the structural member would normally be used to define the rough opening in facing relationship with the at least one elongate jamb, the elongate insert in the door assembly being structurally mounted to the respective single thickness structural member so as to provide substantially the same structural strength as the normal double thickness rough opening framing structure.

As used herein, the “jamb face plate” is that portion of the jamb which extends from the interior flange to the exterior flange, and generally connects to the interior flange and the exterior flange.

In a still further family of embodiments, the invention comprehends a combination fastener comprising a fastener body, and as a separate and distinct element, a fastener head. The fastener body has a first set of threads having a first thread configuration extending from a first end of the fastener body, and a second set of threads having a second thread configuration extending from a second opposing end of the fastener body. The fastener head comprises a bore extending longitudinally therealong from a first end thereof. The bore comprises inner threads corresponding to the second thread configuration, and a stop disposed in the bore, and toward a second end of the bore from the first end, such that the fastener head can be threaded onto the fastener body, and in cooperation with the stop in the head, can thereby be used to drive the fastener, and to accordingly fasten the fastener to a substrate, and wherein reverse turning of the fastener head turns the fastener head with respect to the fastener body and does not withdraw the fastener body from such substrate.

### BRIEF DESCRIPTION OF THE DRAWINGS

FIG. 1 shows a front elevation view of a prior art door assembly of the invention.

FIG. 2 shows a cross-section of the door jamb, of the door assembly of FIG. 1, taken at 2-2 of FIG. 1.

FIG. 3 shows a cross-section of a portion of a first prior art door frame assembly, not part of the invention.

FIG. 4 shows a cross-section of a portion of a second prior art door frame assembly, not part of the invention.

FIG. 5 shows a cross-section of a portion of a third prior art door frame assembly, not part of the invention.

FIG. 6 shows a cross-section of a portion of a first embodiment of door frame assemblies of the invention, in shipping mode.

FIG. 6A shows a pictorial view of the open side of a hinge jamb assembly, of a door frame assembly of the invention, corresponding generally to the cross-section shown in FIG. 6.

FIG. 6B shows a plan view, partially cut away, of the open side of a hinge jamb assembly, of a door frame assembly of the invention, corresponding generally to the cross-section shown in FIG. 6 and the pictorial view of FIG. 6A.

FIG. 7 shows a plan view of a spacing block used in metal door frame assemblies of the invention.

FIG. 8 shows a cross-section of a portion of a metal door frame assembly of FIG. 6, installed in a doorway rough opening of a building, and secured to the building.

FIG. 9 is a plan view of a mounting fastener preferred for use in mounting a door assembly of the invention in a doorway rough opening of a building.

FIG. 10 is an exploded view of the fastener of FIG. 9.

The invention is not limited in its application to the details of construction or the arrangement of the components set forth in the following description or illustrated in the drawings. The invention is capable of other embodiments or of being practiced or carried out in various other ways. Also, it is to be understood that the terminology and phraseology employed herein is for purpose of description and illustration and should not be regarded as limiting. Like reference numerals are used to indicate like components.

### DESCRIPTION OF THE ILLUSTRATED EMBODIMENTS

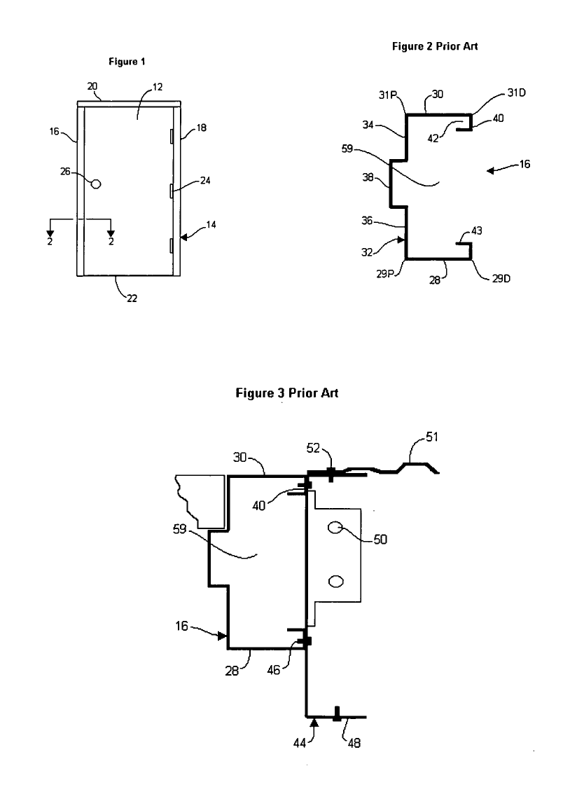

In the invention, the door slab 12 is conventional, and can thus be the same slab illustrated in FIGS. 1, 3, 4, and 5. Accordingly, no further description is given here of the door slab, as any known door slab can be employed, as desired. Also, the jamb 16, 18, illustrated in FIG. 2 is the jamb cross-section preferred for use in the invention.

The invention is embodied generally in the structure and function of the left and right frame jambs, as jamb assemblies, optionally also the frame header jamb. In part, the invention is optionally embodied in the cooperation between the jamb assemblies and the framing of the rough opening in the building, and the methods and apparatus used in mounting the door assembly 10 in the doorway rough opening.

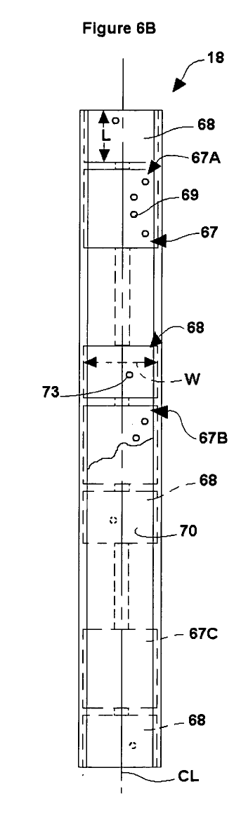

Turning now to FIGS. 6, 6A, 6B and 7-10, which represent specific embodiments of the invention, and especially to FIGS. 6, 6A, 6B, and 8, FIG. 6A shows an elevation view of a hinge-side jamb assembly of the invention, partially cut away, as viewed from the side of the jamb assembly which is to interface with a stud 54 of a rough opening of a building. As seen in FIGS. 6A and 6B, first, second, and third hinge reinforcement plates 67A, 67B, 67C are securely mounted to jamb 18 as by welding, though other methods of known attachment are contemplated. Reinforcement plates 67A, 67B, 67C are e.g. 7 gauge steel, about 0.19 inch thick. As shown, the reinforcement plates are mounted to the inside surfaces of rabbet sections 34, 36, and are disposed opposite the mounting loci of hinges 24. Reinforcement plates 67 include drilled and threaded mounting holes 69. Hinges 24 are mounted to hinge jamb 18 by fasteners (not shown) which extend through the respective hinge leaves, and secure to the reinforcement plate 67 at the respective holes 69.

Spacing blocks 68 are inserted into the inner space 59 inside the jamb, and against the inner surfaces of rabbets 34, 36, and bridging across door stop 38. In the embodiments shown, spacing blocks 68 are laterally displaced from plates 67, and are typically generally spaced along the length of jamb 18. Specific locations for blocks 68 are selected as locations which can provide a level, e.g. planar, surface to receive insert 70, blocks 68 not overlying plates 67, where the jamb is most likely to receive mechanical stress during the use life of door assembly 10. The overall purpose of spacing blocks 68 is to support the steel jamb, , e.g. jamb 16 or 18, thus to facilitate the jamb being able to resist such mechanical stresses while attenuating or avoiding independent movement of the jamb, independent of corresponding movement of the building into which the jamb, e.g. door assembly, is installed. Namely, spacing blocks 68 provide clearance above plates 67, thus to provide clearance between plates 67 and insert 70, as effected at inner surface 71 of blocks 68. Further to that end, a fastening aperture is preferably fabricated in door stop 38 opposite each spacing block 68, whereby a fastener can be driven through the jamb face plate, through the spacing block 68, and illustratively into insert 70 and a building framing member as described hereinafter.

A spacing block 68, as illustrated, has a width dimension “W” which preferably corresponds with the corresponding inner width dimension of inner space 59 between inner 28 and outer 30 flanges of the jamb. Accordingly, spacing blocks 68 preferably have a friction, e.g. wedging, fit spanning between flanges 28 and 30.

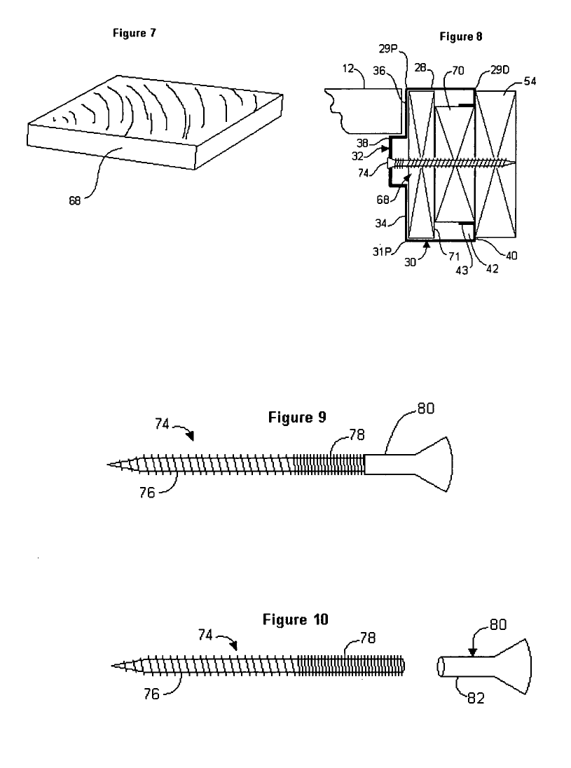

A spacing block 68 has a length “L” extending along the length of jamb 18. Length “L” should be sufficiently great to prevent substantial rotation of the block relative to an axis which is perpendicular to the plane of the sheet of paper on which FIG. 6A is illustrated. Typically, the dimension of length “L” is about the same as the dimension of width “W”, whereby spacing block 68, as illustrated in FIG. 7, is preferably about square. On the other hand, the dimensions “L” and “W” can vary widely in the invention so long as the spacing block 68 satisfactorily provides the clearance and performs the spaced blocking function, and provides a consistent reception surface described hereinafter. For example, the entirety of the length of the jamb, between plates 67, can be filled with spacing blocks. However, as shown and for purposes of economy of cost, spacing blocks 68 are preferably located at selected spaced anchor locations to provide a collectively planar surface to receiver insert 70.

Spacing blocks 68 are at least as thick as reinforcing plates 67. Accordingly, where plates 67 are 0.19 inch thick, spacing blocks 68 are at least 0.19 inch thick. Typically, blocks 68 are substantially thicker than plates 67, while not being so thick as to occupy a predominant proportion of the thickness of the inner space between rabbet sections 34, 36, and the outer surface of flange ends 40. A convenient thickness for blocks 68 is the standard thickness of finish-planed, nominally 1-inch thick piece of lumber, namely ¾ inch thickness. Accordingly, in a hinge jamb assembly designed and configured for use with a building having a nominal 6-inch wall thickness, a typical spacing block 68 has a width “W” of 5½ inches, a length of 4¾ inches, and a thickness of ¾ inch. The invention is, of course, not limited in its application to any one building wall thickness. Rather, the invention can be employed in a wide variety of building wall thickness, and with a wide variety of designs of the metal jamb.

Typical material for spacing block 68 is wood, preferably weather-treated wood, preferably treated with an environmentally friendly treatment such as the now-well known copper solution impregnation. Other materials, without limitation, such as manufactured wood products, e.g. chip board or flake board, can be used. In addition, spacing blocks 68 can be made of e.g. polymeric materials, such as for example and without limitation, high density polyethylene, polypropylene, polyvinyl acetates, and a variety of remanufactured and/or recycled plastics products of compatible compositions, which are known for use in the construction trades.

The function of blocks 68, as shown in FIGS. 6 and 8, is to serve as spacers, to provide clearances, spacing, over metal covers, metal reinforcements, in jambs, and to provide additional strength to the metal jamb, wherein the outer surfaces 71 of the blocks are located a common distance, preferably farther away, from rabbet sections 34, 36 than are the corresponding outer surfaces of plates 67. Stated functionally, the outer surfaces 71 of the respective spacing blocks 68 along the length of a jamb define a generally planar mounting surface for receiving a reinforcing insert 70. Outer surfaces 71 are contained in a first common plane, and that plane is not generally interrupted by plates 67, or any other structure located between rabbets 34, 36 and a second plane which connects flange ends 40 at their most distal location from jamb face plate 32. While minor interruptions of the first common plane are tolerated, and in some instances are expedient, the area of such interruptions is de minimis compared to the overall area of the plane inside jamb 18. Further, the depth of penetration of any such interruptions, beyond the first common plane, is preferably minor compared to the depth “D” of the jamb between blocks 68 and flange ends 40.

A given block 68 is typically a cut piece of standard dimension treated lumber, such as ¾ inch thick, nominally 6-inch wide lumber, which fills the width of the jamb space between inner and outer flanges 28, 30. Blocks 68 may be any thickness sufficient to successfully bridge door stop 38, and to provide support against rabbets 34 and 36 while providing an effective level, e.g. planar, mounting surface to receive the reinforcing insert. As illustrated in FIG. 6A, on hinge jamb 18, blocks 68 are preferably placed adjacent the hinge reinforcement plates 67.

Returning to FIGS. 6 and 6A, a single reinforcing wood jamb insert 70 is positioned against spacing blocks 68, whereby surfaces 71 collectively provide a surface against which insert 70 is mounted. Insert 70 generally fills that portion of inner space 59 which is disposed over spacing blocks 68 and up to those edges of flange ends 40 which are most distal from jamb face plate 32, and between the distal ends 43 of flange ends 40. Since the dimensions of wood do change, insert 70 can extend a modest distance beyond flange ends 40 and thus outwardly of space 59, such as up to about ½ inch, preferably no more than about ⅛ inch, beyond flange ends 40. However, it is highly desirable that insert 70 extend at least as far as flange ends 40, whereby, in preferred embodiments, the thickness of insert 70 generally corresponds with dimension “D”, plus ¼ inch minus zero.

Insert 70 is a treated wood board, sized specifically to fit, preferably to friction fit tightly, into the allocated space, shown in FIG. 6. Wood insert 70 extends generally the full length of the respective jamb, the full depth “D”, and the width of the jamb between distal ends 43 of the flange ends 40. The outer surfaces of insert 70 are generally planar and continuous along the full length of the insert. Suitable cut-outs can be made in insert 70, e.g. as necessary for the jamb face plate, dust cover and any other hardware which is inserted into the jamb assembly, to facilitate operation of the door and/or jamb. Namely, such cutouts are made to receive any structure of the respective jamb assembly which extends beyond the common plane which is defined by outer surfaces 71 of the spacing blocks 68.

In less preferred embodiments, insert 70 can comprise multiple separate and distinct insert segments, each occupying a separate and distinct portion of the length of the jamb, and which cooperatively provide a degree of the functional strength, integrity, and bending and twisting resistance which inheres in insert 70 when the insert is embodied in a single structural element. The greater the dimension of each insert element, relative to the overall length of the particular jamb of interest, e.g. left jamb, right jamb, and the fewer the number of insert elements, resultingly the greater the degree to which the insert elements collectively provide the desired functions of resistance to bending, twisting, and like forces which urge dimensional changes, or movement relative to the building, once the insert is installed in inner space 59 and the jamb assembly is installed in a building.

When multiple jamb inserts are used, adjacent inserts can be spaced from each other thus to receive into such spaces such elements of the jamb assembly which extend beyond the plane defined by outer surfaces 71 of the spacing blocks.

It is also contemplated that insert 70 can be provided as multiple elements which collectively fill the depth “D”, or which collectively span at least the distance between distal ends 43. Such multiple element inserts can be satisfactory so long as they provide the desired reinforcement of the jamb and accommodate attachment to the building such that the jamb assembly does not typically move independent of the building member to which it is attached.

In the illustrated configuration, spacing blocks 68 space the wood jamb insert 70 from any longitudinally intermittent variations of the inner surfaces of rabbets 34, 36 from flat surfaces, and from any other intrusions into space 59 such as by plates 67, which extend from rabbets 34, 36 in a direction generally toward flange ends 40. Blocks 68 also provide solid fill structure to solidly anchor insert 70 against rabbets 34, 36, and thus generally against jamb face plate 32. Spacing blocks 68 also limit the distance between rabbets 34, 36 and wood insert 70, and thereby assist in limiting flexing of inner and outer flanges 28, 30. Flexing can be further limited by using a greater number of spacing blocks 68, or longer spacing blocks, so long as blocks 68 do not overlie the various jamb structure elements such as hardware associated with the strike or the hinges, so as to fail to provide common surfaces 71 to receive a common plane thereat. However, spacing blocks 68, or portions of spacing blocks 68, can overlie such hardware, e.g. plates 67, so long as the blocks are sized and configured to cooperatively accommodate a common mounting surface defined by the plane which extends along surfaces 71. If desired, such overlying blocks 68 need not extend as far as the common, e.g. mounting plane.

As illustrated in FIGS. 6, 6A, 6B, and 8, insert 70 interfaces with jamb 18 at three spatially-displaced points at a given locus along the length of the jamb, namely (i) at the four spacing blocks 68 which are solidly mounted against the jamb face plate, (ii) at the in-turned flange end 40 on inner flange 28 and (iii) at the in-turned flange end 40 on outer flange 30. Given such spaced interfaces, given the forced friction, e.g. wedged, fit, the use of insert 70 results in a substantial stiffening of the jamb assembly, itself.

The jamb assembly is assembled, and used, as follows. Referring to FIGS. 6 and 6A, 6B, an e.g. hinge jamb 18 is laid on a horizontal surface with door stop 38 oriented down, and with the open face of the jamb oriented upwardly. Such jamb has already been fitted with any hardware conventionally associated with the hinges, or the strike or jamb face plate in the case of a strike jamb. Accordingly, in a hinge jamb, hinge reinforcement plates 67 are already permanently mounted in place in the jamb. In the illustrated embodiment, plates 67 are welded to jamb 18.

Blocks 68 are inserted into space 59, against rabbets 34, 36, and adjacent plates 67, as shown in FIG. 6A. Blocks 68 should not overlie plates 67, but can be touchingly-adjacent plates 67. Next, insert 70 is emplaced, friction fit into the remaining void space between flange ends 40, as shown in FIG. 6 and abutted against spacing bocks 68 at surface 71.

With the blocks 68 and insert 70 thus temporarily held in place by friction, a plurality of nails are driven through insert 70 and into blocks 68, thus to permanently join blocks 68 and insert 70 to each other, in inner space 59.

Next, the work piece, including jamb 18, blocks 68, and insert 70, is turned over. Pilot holes are drilled through apertures 73, thence through blocks 68, and into insert 70 as desired or as necessary. Temporary draw screws 72 are installed through the above-noted apertures 73, through blocks 68 and into insert 70, and are used to draw insert 70 tight against spacing blocks 68, and thus to draw spacing blocks 68 tight against jamb face plate 32. Such drawing generally straightens any minor warpage of wood insert 70 against the straight surfaces of rabbets 34, 36 along the length of jamb 18, whereby the structure of jamb 18 serves as a base for straightening any warpage of insert 70. Preferably, draw screws 72 are employed at each spacing block 68. However, at the discretion of the user, draw screws 72 can be employed at fewer than all of apertures 73. However, at least one such draw screw is preferably used in each jamb assembly which embodies spacing, blocks 68 and insert 70, thus to securely hold the spacing blocks and insert properly positioned in the jamb assembly until the jamb assembly reaches the job site.

As shown in FIG. 6, temporary draw screw 72 preferably passes through door stop 38, through spacing block 68, and into insert 70, preferably a screw at each spacing block, thus to provide secure assembly of spacing blocks 68 and insert 70 to the jamb when the door assembly is shipped to the job site. In the alternative, insert 70 can be so dimensioned, and the jamb so configured, that the friction fit between insert 70 and distal ends 43 of flanges 40 of the jamb is sufficient to retain the insert in inner space 59 without any assist of any fasteners. In some embodiments, insert 70 and/or distal ends 43 can be configured to define a cooperative snap-fit between ends 43 and the respective cooperating surfaces of insert 70. In addition, spacing blocks 68 can be so dimensioned as to be held in the cavity defined by inner space 59 only by friction fit between the blocks and inner and outer flanges 28 and 30. In general, though, use of draw screws 72 is preferred.

Apertures 73 are preferably alternately spaced on opposing sides of an imaginary centerline “CL” extending along the length of door stop 38, as illustrated in FIG. 6A.

Referring to FIG. 8, and as an overview, door frame 14 is preferably shipped to the job site completely assembled, including left and right jambs 16, 18, header jamb 20, threshold 22, and door slab 12. In such assembly, left and right jambs 16, 18 have spacing blocks 68 and inserts 70 already mounted therein. Header jamb 20 permissively can have spacing blocks 68 and insert 70, but typically such is not needed.

At the job site, the door assembly is tipped into the rough opening, represented by stud 54 in FIG. 8, without necessity of any further modification of the door assembly. The temporary screws are removed. Longer permanent screws 74, shown in FIG. 8, are screwed into the same apertures 73 in door stop 38, and are advanced into a building member, e.g. a stud, framing the doorway opening. Screws 74 thus provide anchors which serve as the anchor structure which anchors the door assembly to the building.

As a first benefit of the invention, insert 70, illustrated in the structure shown in FIGS. 6, 6A, and 8, by filling the space in the jamb inwardly of spacing blocks 68, e.g. toward flange ends 40, and in combination with the interface provided by the spacing blocks to jamb 16, especially at jamb face plate 32, provides structural rigidity to the resulting jamb assembly. Screws 74 are generally located, along the length of the jamb, so as to attach to, and pass through, blocks 68 thus to provide only a minimal open distance between the jamb, at door stop 38, and a spacing block 68, at each screw. Since insert 70 is not intended to provide security against terrorist or other war-related incidents, since cost is a substantial consideration, since the bracing of the inserts with respect to jamb face plate 32 and flanges 28 and 30 are substantial elements of the stiffening function of inserts 70, inserts 70 are not made of metal. Rather, inserts are made of lesser cost, lesser density material, whereby the mass of the inserts does not become a substantial concern regarding difficulty of moving, transporting, and the like, with respect to the inserts.

One consideration in selecting the number of blocks 68 which are to be used, in a particular implementation of the invention, is to consider the number of screws 74 which are to be used to anchor the jamb assembly to the building. Where e.g. relatively longer spacing blocks are used, multiple screws 74 can optionally be used at spaced locations with a given spacing block. Such full-depth support of the jamb, from a plane extending across ends 40 to the inner surfaces of rabbets 34, 36, provides substantial resistance to flexing of the jamb, as well as providing structural support to the building at the rough opening. Namely, the securing process, as well as the support of insert 70 and spacing blocks 68, draws the jamb securely into engagement with the e.g. framing members of the building, whereby the jamb is thus firmly anchored to the building.

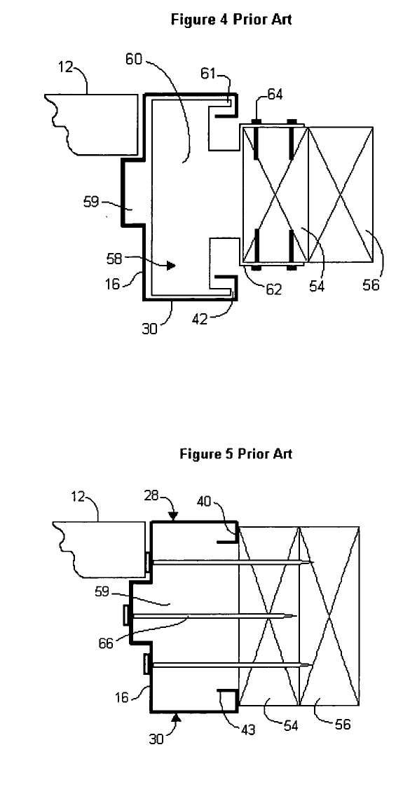

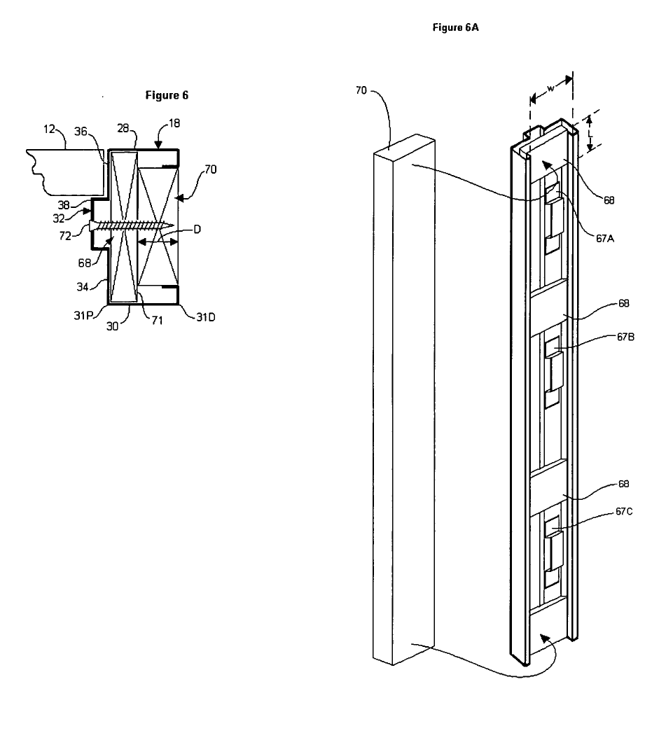

Given the presence of wood insert 70 in the jamb, given the structural support and flex resistance which are provided to the jamb assembly by insert 70, given the structural support and flex resistance which are provided to the building when the jamb assembly is so mounted to the building, the rough opening in the building can be made with a single stud thickness as shown in FIG. 8. Thus, the standard second stud 56 (FIGS. 4 and 5) is obviated, and can be omitted. Accordingly, the quantity of lumber, which is normally required to make a rough doorway opening, is typically reduced by half, resulting in savings in cost of framing lumber and cost of framing labor. Thus, not only can framing cost be reduced, the resultant installed door assembly is so stiff and rigid, and is so rigidly mounted to the building, as to move in a unitary manner in common with movements of the building. Namely, the installed door assembly does not move independently of the building.

Since the permanent screw 74 remains outwardly of the door slab in an in-swing door installation, a special screw, generally known as a fully threaded hanger bolt, is used as permanent screw 74. As illustrated in FIGS. 9 and 10, the screw body, nominally 5/16 inch diameter, has a first end which bears threads 76 which are suitable for screwing the screw into wood, and a second end which bears conventional machine screw threads 78, e.g. 18 pitch threads. Special screw 74 has a special detachable screw head 80, which has a hollow shaft 82, thus contains a bore. Shaft 82 is threaded on its inner surface, namely in the bore, with the same 18 pitch machine screw threads, to a stop, e.g. a dead end of the bore, at a depth of 11/16 inch in the illustrated embodiment, whereby the bore threadedly receives the threads 78 of the second end of screw 74.

As the door assembly is mounted in the doorway rough opening, once the door assembly is shimmed in a conventional manner, regular clockwise turning force is applied to screws 74 at head 80, whereby screws 74 are advanced through spacing blocks 68, through insert 70, and into stud 54, and are thus used to mount the jamb elements, namely the jamb 16 or 18, spacing blocks 68, and insert 70, thus the door frame, to the building studs 54, as discussed above. In such process, the dead end of the bore limits the turning of head 80 with respect to screw body 76 when the screw body reaches the dead end of the bore, and thus forces the screw body to turn with the screw head.

When screw 74 is fully installed, threads 76 are firmly embedded in both insert 70 and stud 54, optionally spacing block 68 as applies, thus securely holding door assembly 10 to the building independent of any location or configuration of head 80, indeed regardless of the presence or absence of head 80. Thus, if during such mounting to the building, a screw 74 is advanced further than it should be, head 80 can be backed off, e.g. turned in the reverse direction which is typically a counter clockwise direction, to the extent needed to correct the depth of head 80, without disturbing the grip of threads 76 in the wood, thus without loosening the grip of threads 76 on either insert 70 or stud 54, optionally spacing block 68 as applies, while maintaining firm engagement with the jamb. Counter clockwise, e.g. loosening turning of head 80 merely turns the head relative to the screw body, whereby the screw body is not withdrawn from spacing block 68, insert 70, or stud 54.

Thus, if anyone, e.g. an unauthorized person, attempts to remove the screws or otherwise manipulates head 80, thus to remove the door assembly thereby to breach the security provided by the door, only heads 80 are removed, leaving the wood screw portions 76 of the threads still firmly mounting the door frame to the building. Namely, any manipulation of head 80 after the screw body 76 is installed, is ineffective to remove the screw body from stud 54, spacing block, or insert 70. And since the jambs 16, 18, 20, are securely mounted to spacing block 68 and insert 70, neither can the jambs be readily separately removed from the door assembly. The result is improved building security on any swing of door for an e.g. post wood frame building.

While insert 70 has been described as one or more solid pieces of material, e.g. generally without holes, apertures, depressions, voids, cavities, and the like, insert 70 is not, in general so limited. Insert 70 can include such spatial reductions or omissions in material so long as the desired levels of resistance to deformation of the jamb assembly, and desired unity of movement with the building, are obtained in the resultant door assembly.

The hinge jamb assembly corresponding to jamb 18 has been described in some detail above. The strike jamb assembly corresponding to jamb 16 of FIG. 1 is structured in a generally similar manner. The strike jamb assembly starts with a base jamb as at FIG. 2. Any desired reinforcements, such as plates 67, can be optionally installed. The strike hardware is installed. Spacing blocks 68 are then added, followed by insert 70, or multiple inserts or insert elements, as desired, thus to generally add rigidity to the resultant jamb assembly. The resulting strike jamb assembly is then assembled to a respective hinge jamb assembly 18, a header jamb 20, and threshold 22 as desired, to form a resultant door assembly. In general, the header jamb 20 includes only the metal jamb base corresponding to strike jamb 16 or hinge jamb 18, but without the hinge or strike reinforcements. Accordingly, the header jamb does not include an insert 70 in the illustrated embodiments. However, an insert 70, and optionally corresponding block or blocks 68, can be used in the header jamb if and as desired.

Since the primary interfaces between the door assembly and the building members occurs at the left and right jamb assemblies via jambs 16, 18, any attachment of header jamb 20 to the building members is optional and, even if employed, need not be as secure or as rigid as the attachments of the left and right jamb assemblies. Accordingly, use of spacing blocks 68, insert 70, and screws 74 in header jamb 20 is optional.

In light of the above description, the exterior appearance of door assemblies of the invention, and jambs used in the invention, are permissively included in the embodiment illustrated in FIGS. 1 and 2.

The invention, thus, provides substantial benefit, for example and without limitation, in the forms of:
(i) improved door frame rigidity and flex resistance;
(ii) improved securement and improved rigidity of the interface between the door assembly and the building structure/frame, with corresponding greater tendency of the door assembly and the building members to move together in response to forces which tend to move especially the door assembly;
(iii) reduction in materials and labor required for framing a doorway opening;
(iv) Improved security of attachment of the door assembly to the building for any swing type of door;
(v) novel fasteners which provide improved security against unauthorized tampering with an in-swing door assembly;
(vi) easier alignment and shimming of the door in the doorway opening at installation; related to having a full width of the jamb, along the width of insert 70, for shim contact, anywhere along the length of the jamb assembly;
(vii) fewer anchors, fasteners need to install the door; and
(viii) resulting installation time, installation labor, is reduced compared to prior art doors.

Those skilled in the art will now see that certain modifications can be made to the apparatus and methods herein disclosed with respect to the illustrated embodiments, without departing from the spirit of the instant invention. And while the invention has been described above with respect to the preferred embodiments, it will be understood that the invention is adapted to numerous rearrangements, modifications, and alterations, and all such arrangements, modifications, and alterations are intended to be within the scope of the appended claims.

To the extent the following claims use means plus function language, it is not meant to include there, or in the instant specification, anything not structurally equivalent to what is shown in the embodiments disclosed in the specification.

1. A jamb assembly, adapted for use in a door frame, and comprising:
(a) an elongate jamb having a length, and comprising an inner flange (28) having a first proximal edge and a first distal edge, an outer flange (30) having a second proximal edge and a second distal edge, and a jamb face plate (32) extending between said inner flange at the first proximal edge and said outer flange at the second proximal edge, said elongate jamb defining an elongate cavity therein extending along the length of said elongate jamb, and extending from at or adjacent an inner surface of said jamb face plate to an elongate opening proximate the first and second distal edges of said inner and outer flanges, the elongate opening being defined along the length of said elongate jamb between said inner and outer flanges; and
(b) as a separate and distinct element, at least one elongate reinforcing insert, having a length, received in the elongate cavity and extending at least to the elongate opening, said reinforcing insert operating to increase stiffness of said jamb assembly.

2. A jamb assembly as in claim 1 wherein said elongate reinforcing insert interfaces either directly or indirectly with said elongate jamb at at least three spatially-displaced points at a given locus along the length of said elongate jamb.

3. A jamb assembly as in claim 1 wherein said elongate reinforcing insert interfaces either directly or indirectly with said elongate jamb at at least three spatially-displaced locations along substantially all of the common lengths of said insert and said jamb.

4. A jamb assembly as in claim 1 wherein a width of said elongate reinforcing insert between a first element of said inner flange and a first element of said outer flange extends a distance “D” generally aligned with said inner and outer flanges, thereby filling a substantial portion of the elongate cavity between said jamb face plate and the elongate opening.

5. A jamb assembly as in claim 1 wherein said elongate insert fills substantially all space in the cavity between an element of said inner flange and an element of said outer flange, and fills a substantial portion of all space between the elongate opening and said jamb face plate.

6. A jamb assembly as in claim 4, and including a void space in the elongate cavity between said insert and a second element of at least one of said inner flange and said outer flange.

7. A jamb assembly as in claim 5, and including a void space in the elongate cavity between said insert and a second element of at least one of said inner flange and said outer flange.

8. A jamb assembly as in claim 1, further comprising at least first and second spacing blocks (68) disposed between said insert and said jamb face plate.

9. A jamb assembly as in claim 8, said spacing blocks collectively providing a mounting surface which receives a corresponding surface of said insert.

10. A jamb assembly as in claim 8, said spacing blocks being spaced from each other along the length of said jamb.

11. A jamb assembly as in claim 2, further comprising at least first and second spacing blocks (68) disposed between said insert and said jamb face plate, said spacing blocks collectively providing a mounting surface which receives a corresponding surface of said insert, whereby said spacing blocks (68) serve as indirect interfaces between said insert and said jamb face plate.

12. A jamb assembly as in claim 8 wherein said spacing blocks collectively provide a generally planar mounting surface which receives a corresponding surface of said insert.

13. A jamb assembly as in claim 1, further comprising a draw fastener which draws said insert toward said jamb face plate.

14. A jamb assembly as in claim 8, further comprising a draw fastener which draws said insert toward said jamb face plate.

15. A jamb assembly as in claim 11, further comprising a draw fastener which draws said insert toward said jamb face plate.

16. A jamb assembly as in claim 8, said jamb assembly further comprising, in the elongate cavity, one or more elements of door interface hardware (67) permanently mounted to said jamb, said door interface hardware having first thicknesses thereof extending away from said jamb face plate and toward the elongate opening, said spacing blocks collectively providing a mounting surface disposed generally between the elongate opening and said door interface hardware.

17. A jamb assembly as in claim 16, further comprising a draw fastener which draws said insert toward said jamb face plate.

18. A jamb assembly as in claim 16 wherein said door interface hardware interrupts a de minimis portion of, and thereby extends through a de minimis area of, an imaginary plane defining the mounting surface.

19. A jamb assembly as in claim 8, a projected area of said jamb being defined from the direction of the elongate opening, said jamb assembly further comprising, in the elongate cavity, one or more elements of door interface hardware (67) permanently mounted to said jamb, said spacing blocks and said door interface hardware occupying different portions of the projected area of said jamb.

20. A jamb assembly as in claim 8 wherein said spacing blocks extend from said inner flange to said outer flange.

21. A jamb assembly as in claim 20 wherein said spacing blocks are friction fitted between said inner flange and said outer flange.

22. A jamb assembly as in claim 8 wherein both said spacing blocks and said insert are friction fitted between respective portions of said inner and outer flanges.

23. A jamb assembly as in claim 13 wherein both said spacing blocks and said insert are friction fitted between respective portions of said inner and outer flanges.

24. A door assembly comprising a hinge jamb assembly, a strike jamb assembly, and a header jamb or header jamb assembly, at least one of said hinge jamb assembly and said strike jamb assembly comprising a jamb assembly as in claim 1.

25. A door assembly comprising a hinge jamb assembly, a strike jamb assembly, and a header jamb or header jamb assembly, at least one of said hinge jamb assembly and said strike jamb assembly comprising a jamb assembly as in claim 3.

26. A door assembly comprising a hinge jamb assembly, a strike jamb assembly, and a header jamb or header jamb assembly, at least one of said hinge jamb assembly and said strike jamb assembly comprising a jamb assembly as in claim 4.

27. A door assembly comprising a hinge jamb assembly, a strike jamb assembly, and a header jamb or header jamb assembly, at least one of said hinge jamb assembly and said strike jamb assembly comprising a jamb assembly as in claim 5.

28. A door assembly comprising a hinge jamb assembly, a strike jamb assembly, and a header jamb or header jamb assembly, at least one of said hinge jamb assembly and said strike jamb assembly comprising a jamb assembly as in claim 8.

29. A door assembly comprising a hinge jamb assembly, a strike jamb assembly, and a header jamb or header jamb assembly, at least one of said hinge jamb assembly and said strike jamb assembly comprising a jamb assembly as in claim 10.

30. A door assembly comprising a hinge jamb assembly, a strike jamb assembly, and a header jamb or header jamb assembly, at least one of said hinge jamb assembly and said strike jamb assembly comprising a jamb assembly as in claim 12.

31. A door assembly comprising a hinge jamb assembly, a strike jamb assembly, and a header jamb or header jamb assembly, at least one of said hinge jamb assembly and said strike jamb assembly comprising a jamb assembly as in claim 13.

32. A door assembly comprising a hinge jamb assembly, a strike jamb assembly, and a header jamb or header jamb assembly, at least one of said hinge jamb assembly and said strike jamb assembly comprising a jamb assembly as in claim 16.

33. A door assembly comprising a hinge jamb assembly, a strike jamb assembly, and a header jamb or header jamb assembly, at least one of said hinge jamb assembly and said strike jamb assembly comprising a jamb assembly as in claim 19.

34. A door assembly comprising a hinge jamb assembly, a strike jamb assembly, and a header jamb or header jamb assembly, at least one of said hinge jamb assembly and said strike jamb assembly comprising a jamb assembly as in claim 22.

35. A building comprising a doorway, and a door assembly in said doorway, said door assembly comprising a door assembly as in claim 24.

36. A building comprising a doorway, and a door assembly in said doorway, said door assembly comprising a door assembly as in claim 25.

37. A building comprising a doorway, and a door assembly in said doorway, said door assembly comprising a door assembly as in claim 26.

38. A building comprising a doorway, and a door assembly in said doorway, said door assembly comprising a door assembly as in claim 28.

39. A building comprising a doorway, and a door assembly in said doorway, said door assembly comprising a door assembly as in claim 30.

40. A building comprising a doorway, and a door assembly in said doorway, said door assembly comprising a door assembly as in claim 32.

41. A building comprising a doorway, and a door assembly in said doorway, said door assembly comprising a door assembly as in claim 34.

42. A building as in claim 35, said door assembly being mounted in said doorway using a fastener having a detachable head, whereby manipulation of said head is ineffective to remove said fastener from said door assembly.

43. A building as in claim 38, said door assembly being mounted in said doorway using a fastener having a detachable head, whereby manipulation of said head is ineffective to remove said fastener from said door assembly.

44. A building as in claim 40, said door assembly being mounted in said doorway using a fastener having a detachable head, whereby manipulation of said head is ineffective to remove said fastener from said door assembly.

45. A building as in claim 41, said door assembly being mounted in said doorway using a fastener having a detachable head, whereby manipulation of said head is ineffective to remove said fastener from said door assembly.

46. A building doorway, and a door assembly mounted in said doorway, said doorway being defined by a rough opening and building framing members defining the rough opening,
said door assembly comprising a plurality of elongate jambs, each having a length, and comprising an inner flange (28), an outer flange (30), and a jamb face plate (32), and an elongate cavity therein extending along the length of said elongate jamb, and defined between said inner and outer flanges and outwardly of said jamb face plate to an elongate opening into the elongate cavity,
at least one of said elongate jambs further comprising, as a separate and distinct element, at least one elongate reinforcing insert received in the elongate cavity and extending at least to the elongate opening,
said rough opening being defined by a single thickness of structural member used to define a frame of said building in facing relationship with said at least one elongate jamb which comprises said reinforcing insert, and wherein a double thickness of said structural member would normally be used to define said rough opening in facing relationship with said at least one elongate jamb, said elongate insert in said door assembly being structurally mounted to the respective said single thickness structural member so as to provide substantially the same structural strength as the normal double thickness rough opening framing structure.

47. A building comprising a doorway as in claim 46.

48. A building doorway, and a door assembly mounted in said doorway opening as in claim 46 wherein said elongate reinforcing insert interfaces either directly or indirectly with said elongate jamb at at least three spatially-displaced points at a given locus along the length of said elongate jamb.

49. A building doorway, and a door assembly mounted in said doorway opening as in claim 46, said at least one elongate jamb comprising inner and outer flanges, connected to each other by a jamb face plate, and wherein a width of said elongate reinforcing insert between a first element of said inner flange and a first element of said outer flange extends a distance “D” generally aligned with said inner and outer flanges, thereby filling a substantial portion of the elongate cavity between said jamb face plate and the elongate opening.

50. A building doorway, and a door assembly mounted in said doorway opening as in claim 46, said at least one elongate jamb comprising inner and outer flanges, connected to each other by a jamb face plate, further comprising at least first and second spacing blocks (68) disposed between said insert and said jamb face plate, said spacing blocks providing a mounting surface which receives a corresponding surface of said insert.

51. A building doorway, and a door assembly mounted in said doorway opening as in claim 46, said at least one elongate jamb comprising inner and outer flanges, connected to each other by a jamb face plate, said jamb assembly further comprising, in the elongate cavity, one or more elements of door interface hardware (67) permanently mounted to said jamb, said door interface hardware having first thicknesses thereof extending away from said jamb face plate and toward the elongate opening, said spacing blocks collectively providing a mounting surface disposed generally between the elongate opening and said door interface hardware.

52. A building doorway, and a door assembly mounted in said doorway opening as in claim 51 wherein said door interface hardware interrupts a de minimis portion of, and thereby extends through a de minimis area of, an imaginary plane defining the mounting surface.

53. A building doorway and a door assembly mounted in said doorway, as in claim 46, said at least one elongate jamb being secured to said building framing members which define the rough opening by at least one fastener, wherein said fastener comprises a threaded fastener body, and as a separate and distinct element, a fastener head, said fastener body and said fastener head being cooperatively configured such that said head can be mounted on said fastener body and thereafter can be used to drive said fastener body through said jamb assembly and into one of said building framing members which define the rough opening and wherein, after said fastener body had been so driven, said fastener head is ineffective to facilitate removal of said fastener body from the respective said building framing member or from said jamb assembly, whereby manipulation of said fastener head is ineffective for releasing said door assembly from the doorway.

54. A combination fastener comprising a fastener body, and as a separate and distinct element, a fastener head,
said fastener body having a first set of threads having a first thread configuration extending from a first end of said fastener body, and a second set of threads having a second thread configuration extending from a second opposing end of said fastener body,
said fastener head comprising a bore extending longitudinally therealong from a first end thereof, said bore comprising inner threads corresponding to the second thread configuration, and a stop disposed in said bore, and toward a second end of said bore from said first end, such that the fastener head can be threaded onto the fastener body, and in cooperation with said stop in said head, can thereby be used to drive said fastener, and to accordingly fasten said fastener to a substrate, and wherein, once said fastener body is driven into a substrate using said head as a driving tool, said fastener head is ineffective to remove said fastener body from such substrate.
